(19) United States
(12) Patent Application Publication
(10) Pub. No.: US 2025/0288071 A1
(43) Pub. Date: Sep. 18, 2025

(54) MOBILE DEVICE CASE WITH COLOR FILTER

(71) Applicant: Mobile Mood LLC, Bulverde, TX (US)

(72) Inventor: Samuel John Irwin, Bulverde, TX (US)

(73) Assignee: Mobile Mood LLC, Bulverde, TX (US)

(21) Appl. No.: 18/608,489

(22) Filed: Mar. 18, 2024

(51) Int. Cl. A45C 5/03; A45C 11/00; G03B 17/12; H04B 1/3888; H04M 1/04

(52) U.S. Cl. CPC A45C 5/03; G03B 17/12; A45C 11/002; H04B 1/3888; H04M 1/04

(57) ABSTRACT

According to the present invention disclosed herein, there is provided a mobile electronic device case, comprising: a protective case configured to attach to a mobile electronic device; a colored lens; and a track for the colored lens, wherein the colored lens is movable along the track.

### BACKGROUND

Cases for mobile devices have been described in the prior art patent literature.

For example, in U.S. Pat. No. 11,388,967, a cell phone device protector is described. The cell phone device protector may include a backplate body. The backplate body may include an inner side that is flat and does not include perpendicularly rising edges. The backplate body may also include an outer side that is flat and does not include perpendicularly rising edges. The backplate body may also include a cutout portion operable to surround an outer boundary of a camera bump. The cell phone device protector may also include at least one magnet. The magnet may be located within the backplate body. The magnet may also be operable to attached a device body via magnetic force.

KR20100134926 describes a case for a mobile phone, the color of which varies depending on the intensity of the ultraviolet light using a pigment and a sunscreen (ink oxide) in response to sunlight ultraviolet rays. It mixes and adds a pigment to the base material of the mobile phone case, and adjusts the composition ratio with the sunscreen to change the surface color of the case to a predetermined color when exposed to sunlight (ultraviolet ray) of a certain intensity. Due to this, it can also serve as a case that can detect ultraviolet rays. In this principle, the outside and the inside of the case are composed of one arbitrary mark, which allows the user to use it as a tool for measuring the current UV intensity.

However, mobile devices often have lights and cameras and it would be desirable in some circumstances to have a case which alters the color output or input.

### SUMMARY OF INVENTION

Therefore, the present invention provides a mobile device case which filters or transforms the light input or output from the mobile device's flashlight and camera.

According to the present invention disclosed herein, there is provided a mobile electronic device case, comprising: a protective case configured to attach to a mobile electronic device; a colored lens; and a track for the colored lens, wherein the colored lens is movable along the track.

According to another aspect of the present invention, there is provided a mobile electronic device case, comprising: a protective case configured to attach to a mobile electronic device; a lens filter; and a track for the lens filter, wherein the lens filter is movable along the track.

### BRIEF DESCRIPTION OF THE DRAWINGS

FIG. 1 is an illustration of the mobile device case according to an embodiment of the present invention with the colored lens not in use.

FIG. 2 is an illustration of the mobile device case according to an embodiment of the present invention with the colored lens in use.

### DETAILED DESCRIPTION

The present invention allows the user the ability to adjust the color of the flashlight emitted from a mobile device and the color of the image captured by the camera of a mobile device according to the following principles of operation.

The primary feature of the present invention is the inclusion of a sliding colored lens within a case located adjacent to the device's camera lens and flashlight. The colored lens can slide between a position in which it is not covering the flashlight and the camera and a position in which it is in use covering the flashlight and camera.

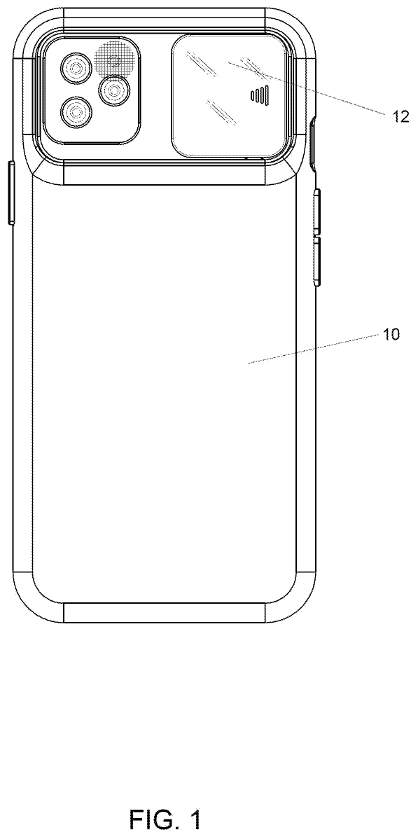

In FIG. 1, colored lens 12 is in a position in which it is not covering the camera lens and flashlight light of mobile device 10.

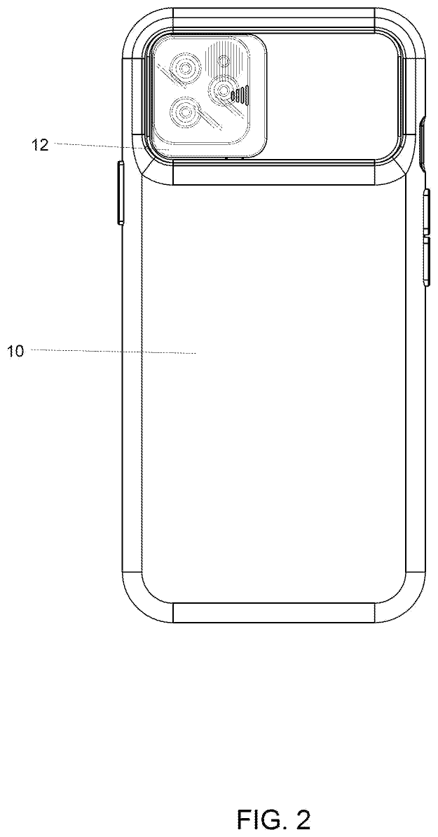

In FIG. 2, colored lens 12 has been moved to a position in which it is covering the camera lens and flashlight light of mobile device 10.

Although it is a common configuration for a mobile device flashlight light and one or more camera lenses to be positioned together on a top corner of a mobile device as shown in FIG. 1 and FIG. 2, there are a variety of other configurations in which the present invention can be utilized.

The colored lens changes how the images look for photography and videography. In some embodiments, the colored lens would only be configured to cover the flashlight light and not the camera lens. The colored lens may also make it possible for only one of multiple lenses of a camera to be covered.

The mobile device case in which the colored lens is positioned can take a variety of forms. It typically comprises a durable and lightweight material. Different versions or the same versions can be compatible with various types and models of mobile devices. The case is designed to snugly fit around the exterior of the mobile device, providing protection against scratches, impacts, and other potential damages.

The sliding mechanism for the colored lenses can consist of a sliding track or rail system. The colored lens can move horizontally or vertically, allowing it to cover or uncover the camera lens and flashlight. The sliding movement can be actuated by a user-operated mechanism such as a button, switch, or lever, which may be located on the side or back of the case for easy access.

Either the lens itself or the entire case can be interchangeable to offer variety in color choice for the colored lenses of the present invention. In some embodiments, the color of the lens can be switched by replacing the lens within the case of the present invention. In other embodiments, different cases can be provided with different color lenses. The cases could be color-coded to indicate the color of the solid-color colored lenses, including but not limited to red, blue, green, yellow, and purple.

More complex lenses and filters could also be used, for example with particular designs or particular colors filtered out. The design of the exterior of the case could be varied in tandem.

Filters help minimize glare and reflections, enhance colors, reduce light coming into the lens, and more. Each lens filter serves a specific purpose, as each one is built to deliver a specific effect that can help enhance the final look of an image.

Polarizing filters, like sunglasses, add depth to an image by saturating its color and reducing reflections. Skylight filters reduce excessive blue cast that often appears in photographs taken outdoors. They can also keep skin tones free of color reflections from objects that are around the subject. Neutral density filters reduce the amount of light that enters a lens and hits the sensor, but without affecting the color of the resulting image. This includes excess sunlight and powerful light from studio flashes.

The illustrations of embodiments described herein are intended to provide a general understanding of the structure of various embodiments, and they are not intended to serve as a complete description of all the elements and features of apparatus and systems that might make use of the structures described herein.

Many other embodiments will be apparent to those of skill in the art upon reviewing the above description. Other embodiments may be utilized and derived therefrom, such that structural and logical substitutions and changes may be made without departing from the scope of this disclosure.

Figures are also merely representational and may not be drawn to scale. Certain proportions thereof may be exaggerated, while others may be minimized. Accordingly, the specification and drawings are to be regarded in an illustrative rather than a restrictive sense.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A mobile electronic device case, comprising:
a protective case configured to attach to a mobile electronic device;
a colored lens; and
a track for the colored lens, wherein the colored lens is movable along the track.

2. The mobile electronic device case of claim 1, wherein the track is positioned for the colored lens to selectively cover and uncover a camera lens of the mobile device.

3. The mobile electronic device case of claim 1, wherein the track is positioned for the colored lens to selectively cover and uncover a flashlight of the mobile device.

4. The mobile electronic device case of claim 1, further comprising one or more additional colored lenses.

5. The mobile electronic device case of claim 4, wherein the track is configured for the colored lens to be replaced by the one or more additional colored lenses.

6. The mobile electronic device case of claim 1, wherein the track has a locking mechanism to secure the colored lens in a desired position.

7. The mobile electronic device case of claim 1, further comprising a button, switch, or lever to move the colored lens along the track.

8. The mobile electronic device case of claim 1, wherein the colored lens is a color selected from the group comprising red, blue, green, yellow, and purple.

9. The mobile electronic device case of claim 1, further comprising a design positioned on the colored lens.

10. A mobile electronic device case, comprising:
a protective case configured to attach to a mobile electronic device;
a lens filter; and
a track for the lens filter, wherein the lens filter is movable along the track.
